(19) United States
(12) Patent Application Publication
(10) Pub. No.: US 2002/0168962 A1
(43) Pub. Date: Nov. 14, 2002

(54) Customized service providing scheme

(75) Inventors: Shoji Kurakake, San Francisco, CA (US); William Alexander Hagen, Montara, CA (US)

Correspondence Address: Dean E. McConnell, Brinks Hofer Gilson & Lione, One Indiana Square, Suite 2425, Indianapolis, IN, 46204, US

(73) Assignee: DoCoMo Communications Laboratories USA

(21) Appl. No.: 09/851,879

(22) Filed: May 9, 2001

(51) Int. Cl. H04K 1/00

(52) U.S. Cl. 455/411; 455/515; 380/247

(57) ABSTRACT

A method and system for providing a customized service in a communication network is disclosed. An initial service request is generated with a terminal. The initial service request is then sent to a service provider server that is connected to the terminal. The initial service request is then analyzed with the service provider server, wherein the step of analyzing the initial service request comprises the steps of: (a) authenticating the terminal to verify that the terminal is authorized to conduct communication on the communication network; (b) ensuring service availability for the terminal by retrieving a service identifier for the terminal from a user information database located on the service provider server; (c) generating an authentication notification based on the results of steps (a) and (b) with the service provider server; and transmitting the authentication notification to the terminal from the service provider server.

### FIELD OF THE INVENTION

The present invention relates generally to communication networks, and more particularly, to methods and systems for providing a customized service to a terminal in a communication network.

### BACKGROUND OF THE INVENTION

Wireless communication networks have brought portable radiotelephony to countless numbers of subscribers around the world. Over the past several years, the use of the Internet to provide various types of services has also become extremely popular. Typically, access to what is commonly referred to as “the Internet” requires a data channel between a user terminal and an access provider. The access provider serves as a gateway for the exchange of data between the user terminal and the various nodes that together comprise the Internet.

Many types of connections between the customer and an access provider are now available, each characterized by varying levels of convenience, expense and transmission efficiency. Currently, most residential users access the Internet via ordinary telephone line with a conventional modem that operates at speeds up to 56 kilobits per second (Kbps). Such users access an Internet service provider or an online service provider by establishing a circuit-switch connection through the public switched telephone network (PSTN). Point-to-point protocol (PPP) sessions to the Internet access point are maintained during the duration of the circuit switch connection.

i-mode is the recent creation of NTT DoCoMo and allows its users to view web sites and send and receive email via mobile terminals. The primary difference between an i-mode service and Internet access via ordinary telephone line is that the Internet connection is constant in the i-mode service. In other words, a terminal using an i-mode service is always connected to the Internet because i-mode service uses packet switch connections over a mobile wireless network.

Mobile wireless networks in addition to high-speed wireline access such as DSL and cable modems, leverage Internet access and more people use the Internet to view and exchange information and content over various communication systems. In the future, it is envisioned that huge number of services will be available that will take advantage of these communication networks. It is obvious that different people demand different services and providing the same services to different people is neither attractive nor effective any more. Therefore, a need exists for a customized service-providing scheme that is capable of categorizing users of communication networks into classes of corresponding services. This will enable services to be provided to specific groups of people, and eventually encourage more service providers to provide various services over communication networks.

### SUMMARY OF THE PRESENT INVENTION

The present invention discloses methods and systems for providing a customized service to a plurality of terminals in a communication network. Preferentially, the communication network is a wireless communication network and operates using a packet-switched communication protocol; however, those skilled in the art would recognize that the present invention may be used in a variety of communication networks. In one preferred embodiment of the present invention, an initial service request is generated with a respective terminal. The initial service request is then sent to a service provider server that is connected to the terminal. After reaching the service provider server, the service provider server is operable to analyze the initial service request to determine if the terminal is authorized to conduct communication on the communication network and has access rights to the requested service.

During operation, when the service provider server analyzes the initial service request, several steps are performed by the service provider server. The first step involves authenticating the terminal to verify that the terminal is authorized to conduct communication on the communication network. Each terminal is assigned a unique identified that associates it with the service provider server. After this task is accomplished, the service provider server ensures service availability for the terminal by retrieving a service identifier for the terminal from a user information database that is preferentially located on the service provider server. The service provider server, based on the results of the above-referenced steps, then generates an authentication notification. Once the authentication notification is generated, it is then transmitted to the terminal via the communication network. Based on the contents of the authentication message, the terminal can either begin conducting communication and receiving the requested service or cannot proceed because of an error notification contained in the authentication notification.

In the preferred embodiment of the present invention, each terminal is assigned a terminal service identifier that associates each particular terminal with a plurality of services that are available on the communication network. These services are associated with each terminal by users of the terminals subscribing or paying for the associated services. As such, although a plurality of services may be available, each terminal will only have access rights to its associated services and services that are not associated with the terminal will not be made available to the terminal.

Once the terminal receives the authentication notification, the contents of the authentication notification are stored in the terminal. If the authentication notification indicates that the terminal is authorized to conduct communication and receive the chosen service, a service request is generated by the terminal that is compliant with the authentication notification. Once the service request is generated, the terminal transmits the service request to the service provider server. The service provider server then authenticates the terminal once again and then provides the requested service to the terminal based on the service request received from the terminal.

The present invention also includes updating a user record database that keeps track of the usage of respective services by each respective terminal. In addition, the service provider server is also preferentially operable to calculate a service charge for the service that is provided to the terminal by the service provider server. The service charge can also be transmitted to the terminal if so desired, so that the user of the terminal can be notified of the respective charges, if there are any charges associated with the chosen service.

Another preferred embodiment of the present invention discloses a method and system of providing a customized service in a communication network. In this embodiment, an initial service request is generated with a terminal. The initial service request that is generated by the terminal preferentially includes a terminal service identifier and a predefined service request. The initial service request is then transmitted to a service provider server that is connected to the terminal. The service provider server then verifies that the terminal has access rights to a service requested by the initial service request by analyzing the terminal service identifier and the predefined service request.

If the terminal is authorized to use the requested service, then an authentication notification that is based on the terminal service identifier and the service request is generated by the service provider server. The authentication notification is then transmitted to the terminal, which, in turn, uses the authentication notification to generate a service request that is then transmitted to the service provider server so that the service provider server can begin providing the service to the terminal. The present invention also includes updating the terminal service identifier based on the usage of respective services by each respective terminal, and the updated terminal service identifier is transmitted to the terminal, and stored in the terminal.

In both preferred embodiments of the present invention, a plurality of service servers are connected to the service provider server. The service servers are preferentially designed to provide a predetermined service that is delivered to the terminals of the communication network via the service provider server, which routes the data communicated to and from the terminals to the service server and vice versa during operation. Those skilled in the art would recognize that a plurality of predefined services are capable of being provided by the service servers. In addition, third-party networks may also be connected to the service provider servers such that a user of the terminals could access an internal company database containing various types of data files or documents, for example.

Further objects and advantages of the present invention will be apparent from the following description, reference being made to the accompanying drawings wherein preferred embodiments of the present invention are clearly shown.

### BRIEF DESCRIPTION OF THE DRAWINGS

FIG. 1 illustrates a preferred communication network that is capable of utilizing the present invention.

FIG. 2 illustrates a flow chart of a preferred method of providing a predetermined service to a terminal that is connected to a service provider server in a communication network.

FIG. 3 illustrates a flow chart of yet another preferred method of providing a predetermined service to a terminal that is connected to a service provider server in a communication network.

### DETAILED DESCRIPTION OF THE PREFERRED EMBODIMENTS OF THE INVENTION

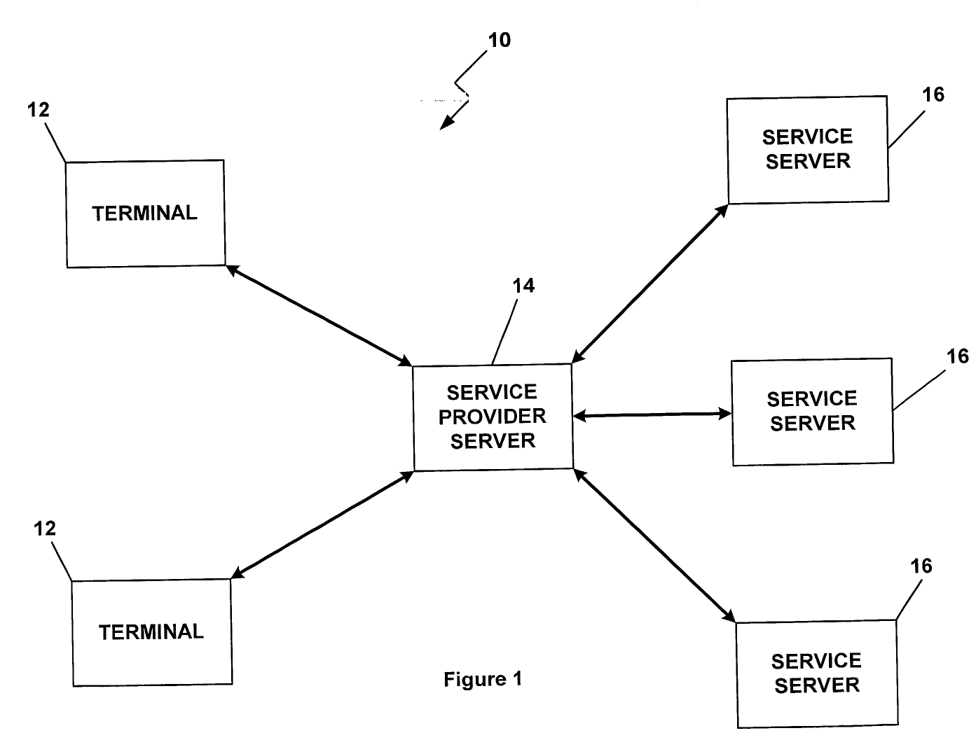

Referring to FIG. 1, the preferred embodiment of the present invention discloses a method of providing a customized service in a wireless communication network 10. Although the preferred embodiment of the present invention is set forth in a wireless communication network 10, those skilled in the art should recognize that the present invention could be used in other communication networks as well. In other words, the present invention can be designed for use in land-based or wireless communication networks that consist of a broad range of network types and components. As such, the disclosure of the preferred embodiment of the present invention as it relates to a wireless communication network 10 should not necessarily be construed as a limitation of the present invention.

In the preferred embodiment of the present invention, the wireless communication network 10 is a packet switch based wireless communication network 10. However, those skilled in the art would appreciate that the present invention may be used in other wireless communication networks as well. In order to gain a better understanding of the present invention, it is important to have a general understanding of how the preferred packet switch based wireless communication network 10 operates while conducting radio communication with a plurality of remote terminals 12. As such, the description below begins with a general description of the packet switch based wireless communication network 10 and then sets forth the preferred methods and systems for providing a customized service in the packet switch based mobile communication network 10.

For the purpose of understanding the present invention, a packet switch based wireless communication network 10 can be viewed as an overlay of an ordinary mobile communication network. However, while normal communication networks are “circuit-switched” (i.e., you need to dial-up), a packet switch based wireless communication network 10 is “packet-switched.” This means that the preferred wireless communication network 10 is, in principle, “always on,” provided that the remote terminal 12 is in an area where a signal from the wireless communication network 10 can reach the remote terminal 12. During operation, when a service item is selected on a handset menu of the remote terminal 12, data associated to the service is immediately downloaded to the remote terminal 12. There is no delay for dialing to set up the connection.

In the preferred embodiment of the present invention, remote terminals 12 should be broadly construed to include mobile phones, personal digital assistance or laptop computers and the like. As set forth above, although the preferred embodiment of the present invention is set forth in a wireless communication network 10 using remote terminals 12, those skilled in the art would recognize that other terminals may be used as well. As such, the present invention may be useful for communication networks that use terminals such as personal computers or “smart appliances” that are connected to a broad range of communication networks.

As illustrated in FIG. 1, the preferred wireless communication network 10 also includes a service provider server 14 that is connected to the remote terminals 12. Although not specifically illustrated in FIG. 1, those skilled in the art would recognize that a plurality of base stations or other related communication devices may be used to connect the remote terminals 12 to the service provider server 14 so that the remote terminals 12 can communicate with the service provider server 14 during operation. As previously set forth, in the preferred embodiment of the present invention, the remote terminals 12 and the service provider server 14 communicate using a packet-switched transmission protocol.

As further illustrated in FIG. 1, the preferred service provider server 14 is connected to a plurality of service servers 16. In the preferred embodiment of the present invention, the service provider server 14 is connected to the service servers 16 via an Internet connection or through other types of communication network connection means such as a private leased high-speed transmission line. The preferred service servers 16 are preferentially operable to provide a plurality of predefined services to the remote terminals 12. Those skilled in the art should recognize that the services provided to the remote terminals 12 by the service servers 16 will vary depending on the type of data or task that each particular service server 16 is operable to provide during operation.

By way of example only, a bank might use a service server 16 that is operable to provide different types of financial services to users of the remote terminals 12. As such, in this example, the remote terminals 12 might be able to view and make financial transactions using a remote terminal 12. An information-based company, such as a newspaper or magazine, for example, could use a service server 16 that is operable to provide subscription-based content to the remote terminals 12. Other service servers 16 could be used to provide video conferencing, network access to third-party data networks, music files or radio broadcasts or various other types of data and services. Those skilled in the art should recognize that the term service server 16 should be broadly construed to include a plurality of different types of servers that are operable to provide content or data to the remote terminals 12 during operation.

In one embodiment of the present invention, the service provider server 14 and service server 16 are different servers, as illustrated in FIG. 1. However, in another embodiment of the present invention, each service server 16 can include service provider server functions and thus there is no need for a separate service provider server 14. Those skilled in the art should recognize that other servers may be used to store data or perform certain functions in the communication network 10.

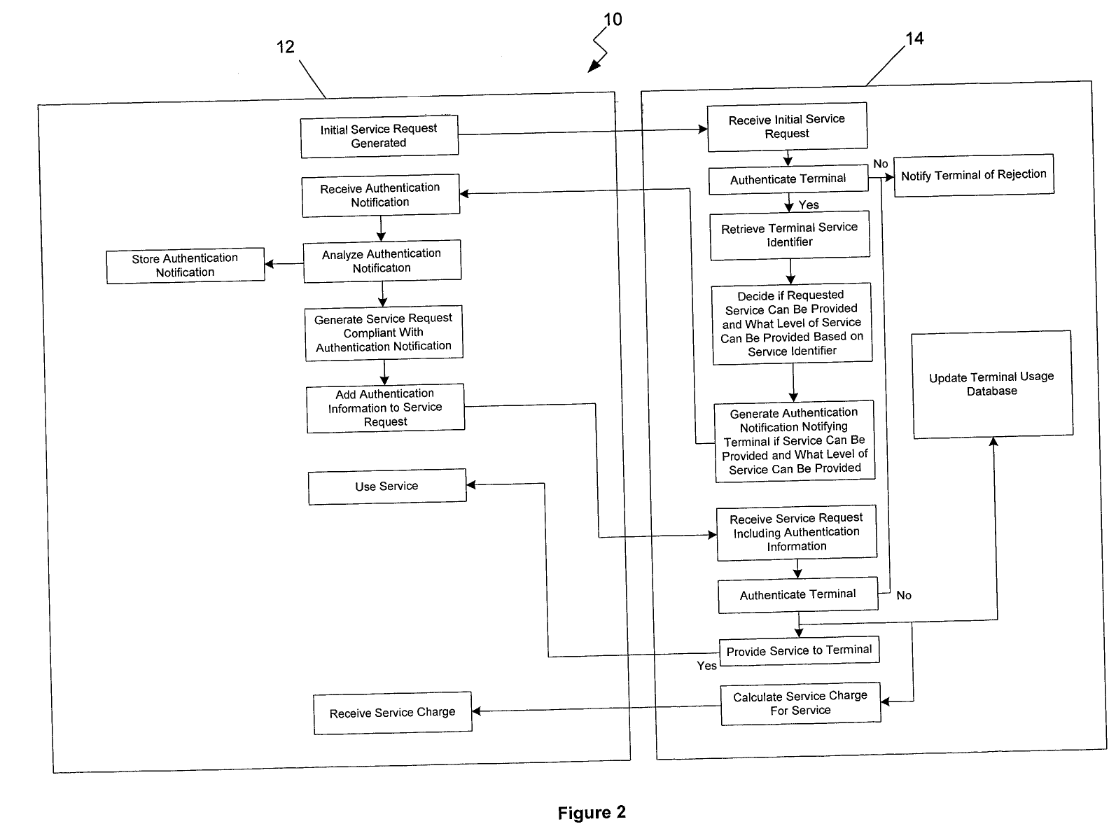

Referring to FIGS. 1 and 2, a preferred embodiment of the present invention discloses a method and system for providing a customized service in a communication network 10. In this preferred embodiment of the present invention, during operation (i.e., when the terminal desires to use a service), an initial service request is generated by the terminal 12 and then transmitted to the service provider server 14. The preferred initial service request includes terminal authentication information that is used by the service provider server 16 to identify the terminal 12. Once the service provider server 14 receives the initial service request, the service provider server 14 analyzes the initial service request to determine if the terminal 12 has access rights to the communication network 10 and if it has access rights to the selected service.

The step of analyzing the initial service request includes the steps of: (a) authenticating the terminal to verify that the terminal 12 is authorized to conduct communication on the communication network 10; (b) ensuring service availability for the terminal 12 by retrieving a service identifier for the terminal 12 from a user information database located on the service provider server 14; and (c) generating an authentication notification based on the results of steps (a) and (b) with the service provider server 14. During operation, if the service provider server 14 does not authenticate the terminal 12, the service provider server 14 generates and transmits a rejection notification to the terminal 12 in the authentication notification. If the terminal 12 is authenticated and has access rights to the requested service, the authentication notification is transmitted to the terminal 12 from the service provider server 14 indicating such to the terminal 12.

Although not illustrated, the authentication notification sent by the service provider server 14 preferentially includes an authentication message and a service level message if the terminal 12 is authenticated and has access rights to the requested service. The authentication message is used by the terminal 12 while the requested service is being used by the terminal 12 to maintain authentication on the service provider server 14 and the service level message is used to determine the level of service that is capable of being provided to the terminal 12. This could include access rights to specific services within the service or network status messages that determine the speed at which data is capable of being transferred to the terminals 12 from the service provider servers 14. For instance, if high-speed data transmission is indicated as being available, high-quality video imaging and sound might be provided to the terminal 12 as a service, but if low-speed data transmission is all that is available, lower quality settings may need to be used by the terminal 12. The example of video imaging and sound should strictly be viewed as an example only and not as a limitation of the present invention.

In the preferred embodiment of the present invention, each respective terminal 12 that is connected to the communication network 10 is assigned and associated with a predetermined service identifier. In this embodiment of the present invention, the service identifier is stored in the service provider server 14 and is used by the service provider server 14 to associate each respective terminal 12 with a predetermined number or level of services that are available via the communication network 10. As previously set forth, the service provider server 14 is preferentially connected to a plurality of service servers 16 that are operable to provide these predetermined services to the terminals 12. As such, the service identifier contains information that is used by the service provider server 14 to determine if the terminal 12 has access rights to respective services that are provided by the service servers 16.

As set forth above, the preferred embodiment of the present invention is designed for a packet-switched communication network 10 that allows the terminals 12 to constantly be connected to the service provider server 16. As such, the service identifier is used by the service provider server 14 to limit the number of services that are associated with respective terminals 12 that use the communication network 10. The present invention allows the service provider server 14 to selectively provide services that are provided from the service servers 16 to the terminals 12. In this way, the service provider server 14 does not have to provide access to all services to the terminals 12, only respective services that each terminal 12 is allowed to use during operation. The service identifier associated with each respective terminal 12 can be modified to add or remove services that each respective terminal 12 has access rights to use.

As illustrated in FIG. 2, once the authentication notification is transmitted to the terminal 12, the terminal 12 is operable to analyze the authentication notification to determine if the terminal 12 has been authorized by the service provider 14 and what level of services is capable of being provided to the terminal 12. In addition, the terminal 12 stores the authentication notification in a predetermined memory location of the terminal 12. If the terminal 12 has been authorized to use the requested service by the service provider server 14, a service request is generated by the terminal 12 that is compliant with the authentication notification. In order to be compliant, the terminal 12 preferentially adds authentication information to the service request that is received in the authentication notification from the service provider server 14. As previously set forth, the authentication notification is stored in the terminal 12, thus making its contents available for use by the terminal 12.

After the terminal 12 generates the service request, the request is transmitted to the service provider server 14. Upon receiving the service request, the service provider server 14 once again authenticates the terminal 12 and then provides the selected service to the terminal 12 if the terminal 12 passes authentication. If the terminal 12 does not pass authentication, the service provider server 14 generates an error notification that is transmitted to the terminal 12. In the preferred embodiment, the selected service is provided to the terminals 12 from the service servers 16 by means of the service provider server 14. As such, the service provider server 14 is used to selectively control how, and what, services are provided to the terminals 12 thereby acting as a gateway between the terminals 12 and the service servers 16. Those skilled in the art should also recognize certain services may also be located and made available locally from the service provider server 14.

As illustrated in FIG. 2, in addition to providing the selected service to the terminals 12, the service provider server 14 can also be operable to update a terminal usage database on the service provider server 14. In the preferred embodiment of the present invention, the terminal usage database could be used to store a record of the usage of a particular service, a terminal identification number, and a public key for each terminal 12. Those skilled in the art would recognize that numerous types of data could be stored in this database and that those listed above are by way of example only and should not be construed as a limitation of the present invention.

The preferred service provider server 14 is also capable of calculating a service charge for the provided service, if a charge is associated with that particular service. For instance, a terminal 12 might have a subscription to a service server 16 that provides music that is capable of being played on the terminal 12 for a certain charge associated therewith. The preferred service provider server 14 keeps track of this information for billing purposes. In addition, the preferred service provider server 12 is also capable of transmitting the service charge to the terminal 12. A user of the terminal 12, if desired, could then view the service charge.

The preferred initial service request preferentially includes a digital signature that is associated with each respective terminal. During operation, a public key is obtained from a user information database that is located on the service provider server 14 and the digital signature is verified by the service provider server 14 by means of the public key. This information is used by the service provider server 14 to authenticate the terminal 12 during operation.

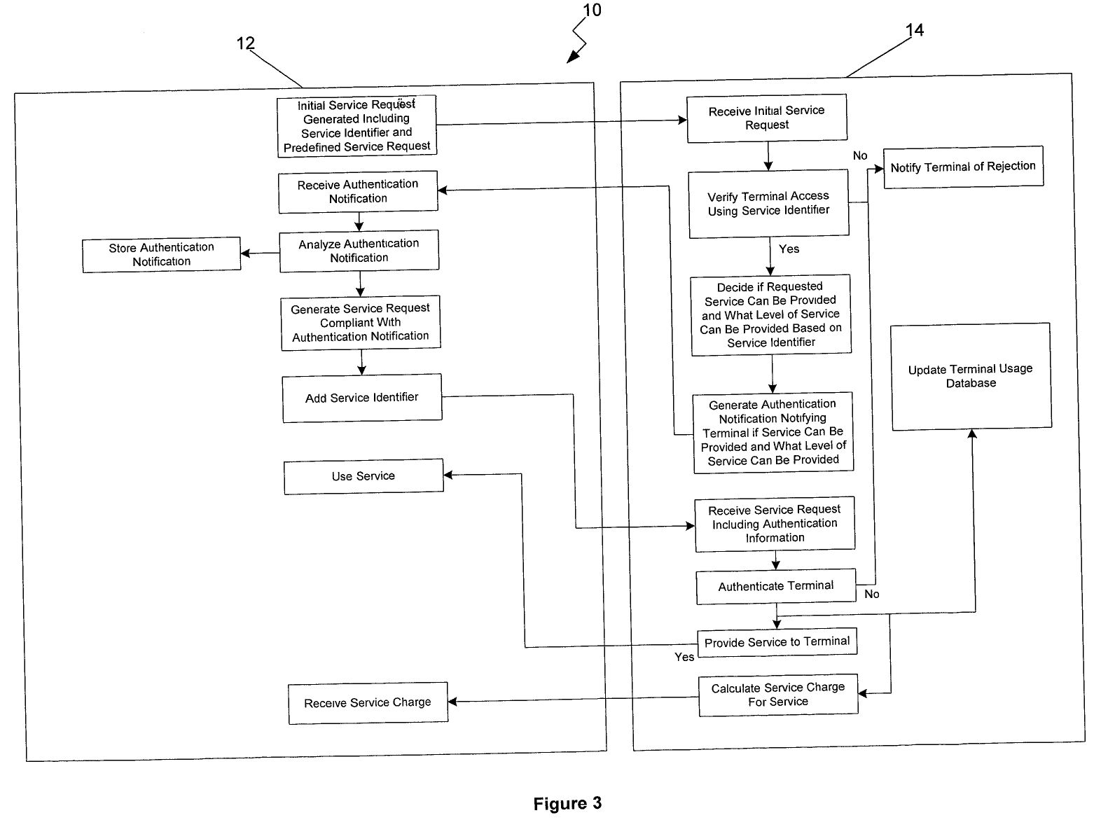

Referring to FIGS. 1 and 3, another preferred embodiment of the present invention discloses a method and system for providing a customized service in a communication network 10. In this embodiment, a terminal 12 creates an initial service request that preferentially includes a terminal service identifier. The initial service request is then transmitted to a service provider server 14 that is connected to the terminal 12. Once the service provider server 14 receives the initial service request from the terminal 12, the service provider server 14 is operable to verify the terminal has access to a service requested by the initial service request by analyzing the terminal service identifier. An authentication notification is then generated by the service provider server 14 that is based on the terminal service identifier and the service request. After the authentication notification is generated by the service provider server 14, it is transmitted from the service provider server 14 to the terminal 12.

In the preferred embodiment, the terminal 12 analyzes the authentication notification to determine if the initial service request has been accepted or rejected by the service provider server. If the initial service request was accepted, at least one service request is generated by the terminal 12 that is compliant with the authentication notification, wherein the service request includes the terminal service identifier. After the service request is generated by the terminal 12, it is transmitted to the service provider server 12, wherein the service provider server 14 verifies the terminal service identifier and provides the requested service to the terminal 12 if the terminal service identifier indicates that the terminal 12 is authorized to receive the service. The remaining features of this embodiment are similar to those discussed with regard to the previous embodiment.

A few operations and associated features should be mentioned with respect to this embodiment of the present invention. First, the terminal service identifier is updated based on the usage of service in the service provider server 14, and transmitted to the terminal 12, and stored in the terminal 12. Second, the updated terminal identifier can be signed by the digital signature of the service provider server 14 so that the service provider server 14 can verify if the terminal service identifier has not been modified by someone other than service provider server 14 or authorized person. In this embodiment, because the terminal 12 sends the terminal service identifier, the service provider server 14 no longer has to keep and manage user and/or a terminal information database, which can become large as the number of authorized terminals 12 increases.

While the present invention has been described with reference to specific exemplary embodiments, it will be evident that various modifications and changes may be made to these embodiments without departing from the broader spirit and scope of the invention as set forth in the claims. Accordingly, the specification and drawings are to be regarded in an illustrative rather than a restrictive sense.

What is claimed is:

1. A method of providing a customized service in a communication network, comprising the steps of:
generating an initial service request with a terminal;
sending said initial service request to a service provider server connected to said terminal;
analyzing said initial service request with said service provider server, wherein the step of analyzing said initial service request comprises the steps of:
(a) authenticating said terminal to verify that said terminal is authorized to conduct communication on said communication network;
(b) ensuring service availability for said terminal by retrieving a service identifier for said terminal from a user information database located on said service provider server;
(c) generating an authentication notification based on the results of steps (a) and (b) with said service provider server; and
transmitting said authentication notification to said terminal from said service provider server.

2. The method of claim 1, wherein said communication network is a packet-switched communication network.

3. The method of claim 2, wherein said terminal is constantly connected to said service provider server by means of said packet-switching communication network.

4. The method of claim 1, further comprising the step of storing said authentication notification in said terminal.

5. The method of claim 1, further comprising the step of generating a service request that is compliant with said authentication notification using said terminal.

6. The method of claim 5, further comprising the step of transmitting said service request to said service provider server.

7. The method of claim 6, further comprising the step of providing a requested service to said terminal based on said service request received from said terminal.

8. The method of claim 7, further comprising the step of updating a user record database based on the usage of said service.

9. The method of claim 7, further comprising the step of calculating a service charge for said provided service with said service provider server.

10. The method of claim 9, further comprising the step of transmitting said service charge to said terminal.

11. The method of claim 1, wherein said initial service request includes a digital signature associated with said terminal.

12. The method of claim 11, wherein the step of authenticating said terminal further comprises the steps of retrieving a public key from a user information database located on said service provider server and verifying said digital signature by means of said public key.

13. A method of providing a customized service in a communication network, comprising the steps of:
generating an initial service request with a terminal, wherein said initial service request contains a terminal service identifier and a predefined service request;
transmitting said initial service request to a service provider server connected to said terminal;
verifying said terminal has access to a service requested by said initial service request by analyzing said terminal service identifier with said service provider server;
generating an authentication notification based on said terminal service identifier and said service request with said service provider server; and
transmitting said authentication notification from said service provider server to said terminal.

14. The method of claim 13, wherein said communication network is a packet-switched communication network.

15. The method of claim 13, further comprising the step of analyzing said authentication notification with said terminal to determine if said initial service request has been accepted or rejected by said service provider server.

16. The method of claim 15, further comprising the step of generating at least one service request that is compliant with said authentication notification using said terminal if said initial service request is accepted, wherein said service request includes said terminal service identifier.

17. The method of claim 16, further comprising the step of transmitting said service request to said service provider server, wherein said service provider server verifies said terminal service identifier and provides said requested service to said terminal if said terminal service identifier indicates that said terminal is authorized to receive said service.

18. The method of claim 17, further comprising the step of calculating a charge for said service with said service provider server.

19. The method of claim 18, further comprising the step of notifying said terminal of said charge by transmitting said charge to said terminal from said service provider server.

20. The method of claim 17, further comprising the step of updating said terminal service identifier based upon the usage of said service.

21. The method of claim 20, further comprising the steps of notifying said terminal of said updated terminal service identifier and storing said updated terminal service identifier in said terminal.

22. The method of claim 15, further comprising the step of generating an error notification on said terminal if said initial service request is rejected by said service provider server.

23. The method of claim 13, further comprising the step of storing said authentication notification in said terminal.

24. A communication network capable of providing a customized service, comprising:
a terminal including means for generating a predefined initial service request when a desired service is requested on said terminal;
a service provider server connected to said remote terminal, wherein during operation, said terminal transmits said initial service request to said service provider server and said service provider server is operable to:
(a) authenticate said terminal to verify that said terminal is authorized to conduct communication using said communication network;
(b) ensure that said desired service is available for said terminal by retrieving a service identifier for said terminal from a user information database stored in said service provider server;
(c) generate an authentication notification based on the results of steps (a) and (b); and
(d) transmit said authentication notification to said terminal.

25. The communication network of claim 24, wherein said communication network comprises a packet-switched communication network.

26. The communication network of claim 24, wherein said terminal stores said authentication notification.

27. The communication network of claim 24, wherein said terminal is operable to generate a service request that is compliant with said authentication message if said authentication message indicates that said terminal is authorized.

28. The communication network of claim 27, wherein said terminal transmits said service request to said service provider server and said service provider server provides said service to said terminal.

29. The communication network of claim 28, wherein said service provider server is operable to provide said service to said terminal based on said service request received from said terminal.

30. The communication network of claim 29, wherein said service provider server is capable of calculating a service charge for providing said service to said terminal.

31. The communication network of claim 30, wherein said service provider server transmits said service charge to said terminal.

32. The communication network of claim 29, further comprising the step of updating a user record database based on the usage of said service.

33. The communication network of claim 24, wherein said initial service request includes a digital signature identifying said terminal.

34. The communication network of claim 33, wherein said service provider server authenticates said terminal by being operable to retrieve a public key from a user information database located on said service provider server and verify said digital signature by using said public key.

35. A communication network capable of providing a customized service, comprising:
a terminal including means for generating an initial service request, wherein said initial service request includes a terminal service identifier and a predefined service request;
a service provider server connected to said terminal;
verifying said terminal has access to a service requested by said predefined service request by analyzing said terminal service identifier;
generating an authentication notification based on said terminal service identifier and said service request; and
transmitting said authentication notification from said service provider server to said terminal.

36. The communication network of claim 35, wherein said communication network comprises a packet-switched communication network.

37. The communication network of claim 35, wherein said terminal is operable to analyze said authentication notification received from said service provider server to determine if said initial service request has been accepted or rejected by said service provider server.

38. The communication network of claim 37, wherein said terminal generates at least one service request that is compliant with said authentication notification if said initial service request is accepted by said service provider server, wherein said service request includes said terminal service identifier.

39. The communication network of claim 38, wherein said terminal is operable to transmit said service request to said service provider server, wherein said service provider server verifies said terminal service identifier and provides said requested service to said terminal if said terminal service identifier indicates said terminal is authorized to receive said service.

40. The communication network of claim 39, wherein said service provider server is operable to calculate a service charge for said requested service.

41. The communication network of claim 40, wherein said service provider server transmits said service charge to said terminal.

42. The communication network of claim 39, wherein said service provider server is operable to update said terminal service identifier based upon the usage of said requested service.

43. The communication network of claim 42, wherein said service provider server notifies said terminal of said updated terminal service identifier and said terminal stores said updated terminal service identifier.

44. The communication network of claim 35, wherein said terminal is operable to generate an error notification if said initial service request is rejected by said service provider server.

45. The communication network of claim 35, wherein said terminal is operable to store said authentication notification in a predetermined memory location of said terminal.
